(19) United States
(12) Patent Application Publication
(10) Pub. No.: US 2017/0175818 A1
(43) Pub. Date: Jun. 22, 2017

(54) SUPERCHARGER COUPLING ASSEMBLY

(71) Applicant: Eaton Corporation, Cleveland, OH (US)

(72) Inventors: Girish Sudhir Kulkarni, Pune (IN); Mark H. Pratley, Marshall, MI (US); Ashok Dnyandeo Shinde, Pune (IN)

(73) Assignee: Eaton Corporation, Cleveland, OH (US)

(21) Appl. No.: 15/454,019

(22) Filed: Mar. 9, 2017

Related U.S. Application Data
(63) Continuation of application No. PCT/US2015/048842, filed on Sep. 8, 2015.

(51) Int. Cl. F16D 1/06; F02B 39/04; F02B 33/38

(52) U.S. Cl. CPC F16D 1/06; F02B 33/38; F02B 39/04; F16D 2200/0004; F16D 2200/0056

(57) ABSTRACT

A coupling assembly arranged between an input shaft and a rotor shaft of a supercharger constructed in accordance to one example of the present disclosure includes a coupling hub and a plurality of pins. The coupling hub can have a series of lobes. Adjacent lobes of the series of lobes can define a plurality of openings. The coupling hub can further define a mounting bore therein. The plurality of pins can have first ends and second ends. The first ends can be correspondingly received by the plurality of openings. The second ends can be received by the rotor shaft. The input shaft can be directly mounted into the mounting bore of the coupling hub for concurrent rotation therewith.

### CROSS-REFERENCE TO RELATED APPLICATIONS

This application is a continuation of International Application No. PCT/US2015/048842 filed on Sep. 8, 2015, which claims the benefit of Indian Patent Application No. 2580/DEL/2014 filed on Sep. 9, 2014. The disclosure of the above application is incorporated herein by reference.

### FIELD

The present disclosure relates generally to superchargers and more particularly to a coupling between an input shaft and a rotor shaft on a supercharger.

### BACKGROUND

Rotary blowers of the type to which the present disclosure relates are referred to as “superchargers” because they effectively super charge the intake of the engine. One supercharger configuration is generally referred to as a Roots-type blower that transfers volumes of air from an inlet port to an outlet port. A Roots-type blower includes a pair of rotors which must be timed in relationship to each other, and therefore, are driven by meshed timing gears which are potentially subject to conditions such as gear rattle and bounce. Typically, a pulley and belt arrangement for a Roots blower supercharger is sized such that, at any given engine speed, the amount of air being transferred into the intake manifold is greater than the instantaneous displacement of the engine, thus increasing the air pressure within the intake manifold and increasing the power density of the engine.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A coupling assembly arranged between an input shaft and a rotor shaft of a supercharger constructed in accordance to one example of the present disclosure includes a coupling hub and a plurality of pins. The coupling hub can have a series of lobes. Adjacent lobes of the series of lobes can define a plurality of openings. The coupling hub can further define a mounting bore therein. The plurality of pins can have first ends and second ends. The first ends can be correspondingly received by the plurality of openings. The second ends can be received by the rotor shaft. The input shaft can be directly mounted into the mounting bore of the coupling hub for concurrent rotation therewith.

According to additional features, the first end of the input shaft can be press fit into the mounting bore of the coupling hub. The second ends of the plurality of pins can be directly received by corresponding openings on the rotor shaft. The series of lobes can consist of three lobes. Additional lobes may be incorporated according to torque transfer requirements for a particular application. The plurality of openings can consist of three openings. The plurality of pins can consist of three pins. Additional pins may be incorporated according to torque transfer requirements.

According to other features, the coupling assembly can further comprise the input shaft. The input shaft can include a first end portion, a second end portion and an intermediate portion. The intermediate portion can connect the first end portion and the second end portion. The first end portion can be coupled to a pulley. The second end portion can be directly mounted into the mounting bore of the coupling hub. The second end portion can have a reduced diameter as compared to the intermediate portion. Each lobe of the series of lobes can have a rib formed thereon, the rib configured to strengthen the coupling hub. The coupling hub can be one-piece. The coupling hub can be formed of over-molded plastic having a metal insert. The metal insert can have a hexagonal outer profile.

According to still other features the metal insert can comprise a series of first planar surfaces that oppose a complementary series of second planar surfaces on the hub body. The first and second planar surfaces cooperate to resist rotation between the hub body and the insert. The insert can further comprise an undercut geometry thereon. The undercut geometry can include a series of insert portions thereon configured to resist axial slip between the insert and the hub body. The plurality of openings can be closed around a circumference of the hub body.

A coupling assembly arranged between an input shaft and a rotor shaft of a supercharger and constructed in accordance to another example of the present disclosure can include a coupling hub and a plurality of pins. The coupling hub can have a series of lobes wherein adjacent lobes of the series of lobes define a plurality of openings. The coupling hub can further define a mounting bore therein. The coupling hub is one-piece and comprises a hub body formed of plastic and an insert formed of metal. The hub body can have a series of first planar portions that oppose a complementary series of second planar surfaces on the hub body. The first and second planar surfaces cooperate to resist relative rotation between the hub body and the insert.

The plurality of pins can have first ends and second ends. The first ends are correspondingly received by the plurality of openings and the second ends are received by the rotor shafts. The input shaft is directly mounted into the mounting bore of the coupling hub for concurrent rotation therewith.

According to other features, the insert includes an undercut geometry thereon. The undercut geometry includes a series of inset portions thereon configured to resist axial slip between the insert and the hub body. The plurality of openings are closed around a circumference of the hub body. The coupling assembly can further include an input shaft that has a first end portion, a second end portion and an intermediate portion that connects the first end portion and the second end portion. The first end portion is coupled to a pulley and the second end portion is directly mounted into the mounting bore of the coupling hub. The second end portion has a reduced diameter as compared to the intermediate portion.

### BRIEF DESCRIPTION OF THE DRAWINGS

The present disclosure will become more fully understood from the detailed description and the accompanying drawings, wherein:

FIG. 1 is a schematic illustration of an intake manifold assembly having a positive displacement blower or supercharger constructed in accordance to one example of the present disclosure;

FIG. 2 is an enlarged, fragmentary, axial cross-section of an input section of the supercharger of FIG. 1 and having a coupling assembly used to couple an input shaft and a rotor shaft according to prior art.

FIG. 3 is an enlarged, fragmentary, axial cross-section of the input section of the supercharger of FIG. 1 and having a coupling assembly used to couple an input shaft and a rotor shaft and constructed in accordance to one example of the present disclosure;

FIG. 4 is front perspective view of the coupling assembly of FIG. 3 including a coupling hub and a plurality of coupling pins shown coupled between the input shaft and a first timing gear of the supercharger of FIG. 3;

FIG. 5 is a front perspective view of the coupling hub of the coupling assembly of FIG. 4;

FIG. 6 is a front perspective exploded view of a coupling hub constructed in accordance to additional features of the present disclosure; and

FIG. 7 is a front perspective view of the coupling hub of FIG. 6.

### DETAILED DESCRIPTION

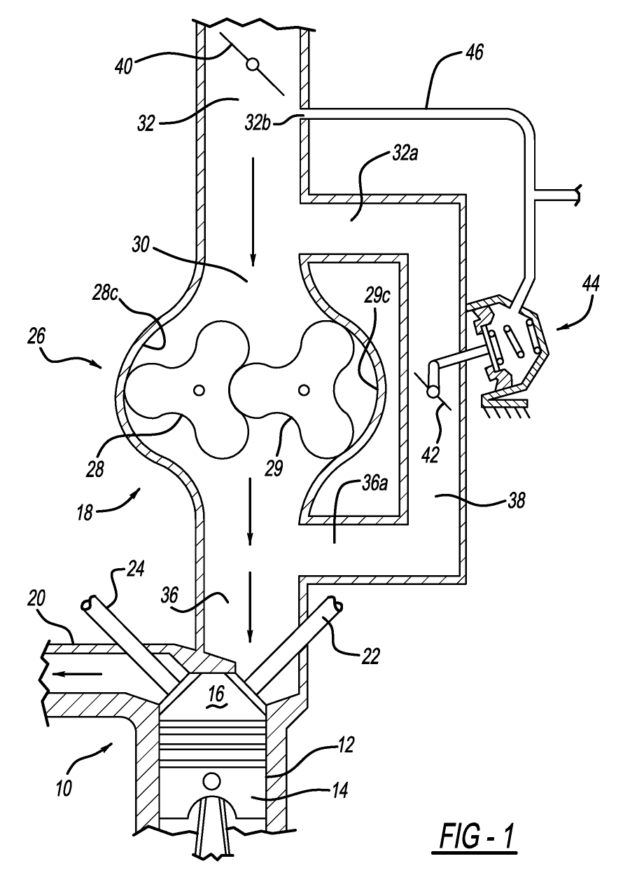

With initial reference to FIG. 1, a schematic illustration of an exemplary intake manifold assembly, including a Roots blower supercharger and bypass valve arrangement is shown. An engine 10 can include a plurality of cylinders 12, and a reciprocating piston 14 disposed within each cylinder and defining an expandable combustion chamber 16. The engine 10 can include intake and exhaust manifold assemblies 18 and 20, respectively, for directing combustion air to and from the combustion chamber 16, by way of intake and exhaust valves 22 and 24, respectively.

The intake manifold assembly 18 can include a positive displacement rotary blower 26, or supercharger of the Roots type. Further description of the rotary blower 26 may be found in commonly owned U.S. Pat. Nos. 5,078,583 and 5,893,355, which are expressly incorporated herein by reference. The blower 26 includes a pair of rotors 28 and 29, each of which includes a plurality of meshed lobes. The rotors 28 and 29 are disposed in a pair of parallel, transversely overlapping cylindrical chambers 28c and 29c, respectively. The rotors 28 and 29 may be driven mechanically by engine crankshaft torque transmitted thereto in a known manner, such as by a drive belt (not specifically shown). The mechanical drive rotates the blower rotors 28 and 29 at a fixed ratio, relative to crankshaft speed, such that the displacement of the blower 26 is greater than the engine displacement, thereby boosting or supercharging the air flowing to the combustion chambers 16.

The blower 26 can include an inlet port 30, which receives air or air-fuel mixture from an inlet duct or passage 32, and further includes a discharge or outlet port 34, directing the charged air to the intake valves 22 by means of a duct 36. The inlet duct 32 and the discharge duct 36 are interconnected by means of a bypass passage, shown schematically at reference 38. If the engine 10 is of the Otto cycle type, a throttle valve 40 can control air or air-fuel mixture flowing into the intake duct 32 from a source, such as ambient or atmospheric air, in a well know manner. Alternatively, the throttle valve 40 may be disposed downstream of the supercharger 26.

A bypass valve 42 is disposed within the bypass passage 38. The bypass valve 42 can be moved between an open position and a closed position by means of an actuator assembly 44. The actuator assembly 44 can be responsive to fluid pressure in the inlet duct 32 by a vacuum line 46. The actuator assembly 44 is operative to control the supercharging pressure in the discharge duct 36 as a function of engine power demand. When the bypass valve 42 is in the fully open position, air pressure in the duct 36 is relatively low, but when the bypass valve 42 is fully closed, the air pressure in the duct 36 is relatively high. Typically, the actuator assembly 44 controls the position of the bypass valve 42 by means of a suitable linkage. The bypass valve 42 shown and described herein is merely exemplary and other configurations are contemplated. In this regard, a modular (integral) bypass, an electronically operated bypass, or no bypass may be used.

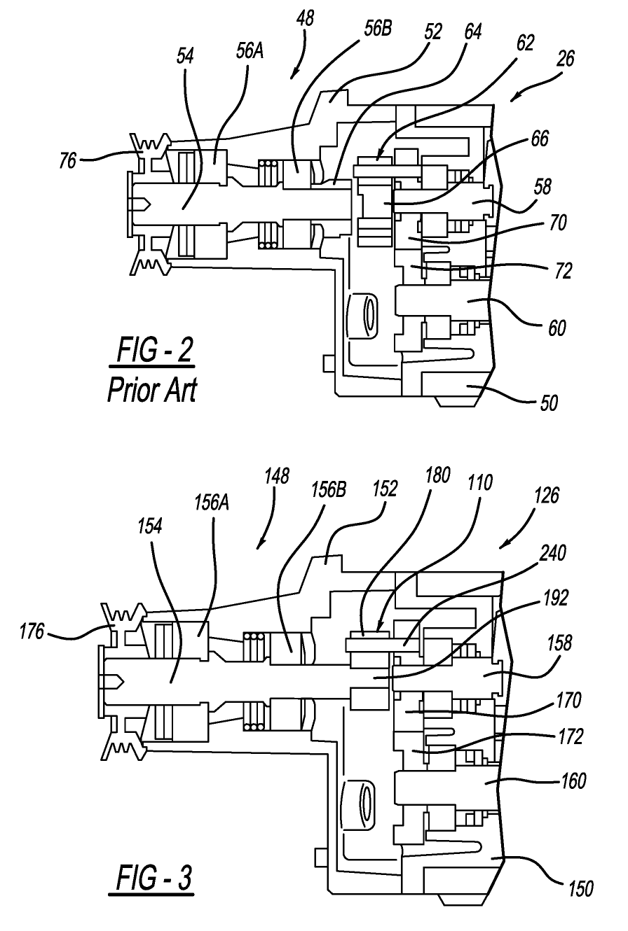

With specific reference now to FIG. 2, an input section 48 of the blower 26 is shown according to one prior art configuration. The input section 48 can include a housing member 50, which forms a forward end of the chambers 28c and 29c. Attached to the housing member 50 is a forward housing 52 within which is disposed an input shaft 54. The input shaft 54 is supported within the forward housing 52 by first and second bearings 56A and 56B, respectively. Rotatably supported by the housing member 50 are a pair of rotor shafts 58 and 60, upon which is mounted the respective blower rotors 28 and 29 (see FIG. 1). A hub pin subassembly 62 couples the input shaft 54 to the first rotor shaft 58. In one example, a first hub 64 can couple the input shaft 54 to the coupling assembly 62 on a first end and a second hub 66 can couple the first rotor shaft 58 to the coupling assembly 62 on an opposite end. A first timing gear 70 may be mounted on a forward end of the first rotor shaft 58. The first timing gear 70 may define teeth that are in meshed engagement with gear teeth of a second timing gear 72 that is mounted on the second rotor shaft 60. The second rotor shaft 60 can be in driving engagement with the blower rotor 29.

In one configuration, positive torque is transmitted from an internal combustion engine (of the periodic combustion type) to the input shaft 54 by any suitable drive means, such as a belt and pulley drive system including a pulley 76. Torque is transmitted from the input shaft 54 to the first rotor shaft 58 through the coupling assembly 62. When the engine 10 is driving the timing gears and the blower rotors 28 and 29, such is considered to be transmission of positive torque. On the other hand, whenever the momentum of the rotors 28 and 29 overruns the input from the input shaft 54, such is considered to be the transmission of negative torque.

With additional reference now to FIGS. 3-5, a coupling assembly 110 constructed in accordance to one example of the present disclosure will be described in greater detail. The coupling assembly 110 can replace the hub pin subassembly 62 described above. As will become appreciated, the coupling assembly 110 provides a simpler configuration as compared to the hub pin subassembly shown in FIG. 2 while using less parts and therefore reduced piece cost and assembly cost. The coupling assembly 110 is shown in a blower 126 where like reference numerals increased by 100 are used.

A first timing gear 170 may be mounted on a forward end of the first rotor shaft 158. The first timing gear 170 may define teeth that are in meshed engagement with gear teeth of a second timing gear 172 that is mounted on the second rotor shaft 160. The second rotor shaft 160 can be in driving engagement with the blower rotor 29 (FIG. 1).

The input section 148 can include a housing member 150, which forms a forward end of the chambers 28c and 29c (see FIG. 1). Attached to the housing member 150 is a forward housing 152 within which is disposed an input shaft 154. The input shaft 154 is supported within the forward housing 152 by first and second bearings 156A and 156B, respectively. Rotatably supported by the housing member 150 are a pair of rotor shafts 158 and 160, upon which is mounted the respective blower rotors 28 and 29 (see FIG. 1).

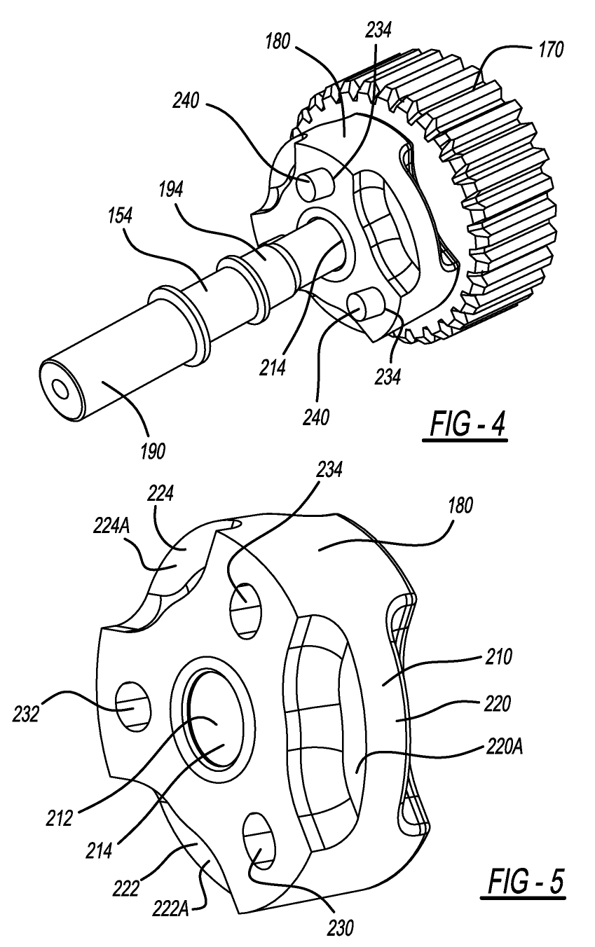

The coupling assembly 110 includes a coupling hub 180 and a plurality of pins 182. The coupling hub 180 can be one-piece or unitary. The coupling assembly 110 couples the input shaft 154 to the first rotor shaft 158. The input shaft 154 can include a first end portion 190, a second end portion 192 and an intermediate section 194. In the example shown (see FIGS. 3 and 4), the first end portion 190 is coupled to the pulley 176. The second end portion 192 is coupled to the coupling hub 180. The second end portion 192 can have a stepped down or reduced diameter as compared to the intermediate section 194. The second end portion 192 can be press-fit into the coupling hub 180 (see also FIG. 3). Explained further, the coupling hub 180 can have a hub body 210 that defines a central bore 212 configured to receive the second end portion 192 of the input shaft 154. The hub body 210 can be formed of over-molded plastic having a metal insert 214. The hub body 210 can further have a plurality of lobes 220, 222 and 224. Additional or fewer lobes may be incorporated according to torque transfer requirements of a particular application. Adjacent lobes 220 and 222 define a first opening or pin receiver 230. Adjacent lobes 222 and 224 define a second opening pin receiver 232. Adjacent lobes 224 and 220 define a third opening or pin receiver 234. The lobes 220, 222 and 224 can include respective ribs 220A, 222A and 224A formed thereon. The ribs 220A, 222A and 224A strengthen the coupling hub 180. The collective pin receivers 230, 232 and 234 are configured to selectively receive first ends of pins 240 (only one specifically shown in FIG. 3 and two shown in FIG. 4). Opposite ends of the pins 240 are received by the first timing gear 170. The pin receivers 230, 232 and 234 can be closed around a circumference of the hub body 210.

In one configuration, positive torque is transmitted from an internal combustion engine (of the periodic combustion type) to the input shaft 154 by any suitable drive means, such as a belt and pulley drive system including the pulley 176. Torque is transmitted from the input shaft 154 to the first rotor shaft 158 through the coupling assembly 110. When the engine 10 is driving the timing gears and the blower rotors 28 and 29, such is considered to be transmission of positive torque. On the other hand, whenever the momentum of the rotors 28 and 29 overruns the input from the input shaft 154, such is considered to be the transmission of negative torque.

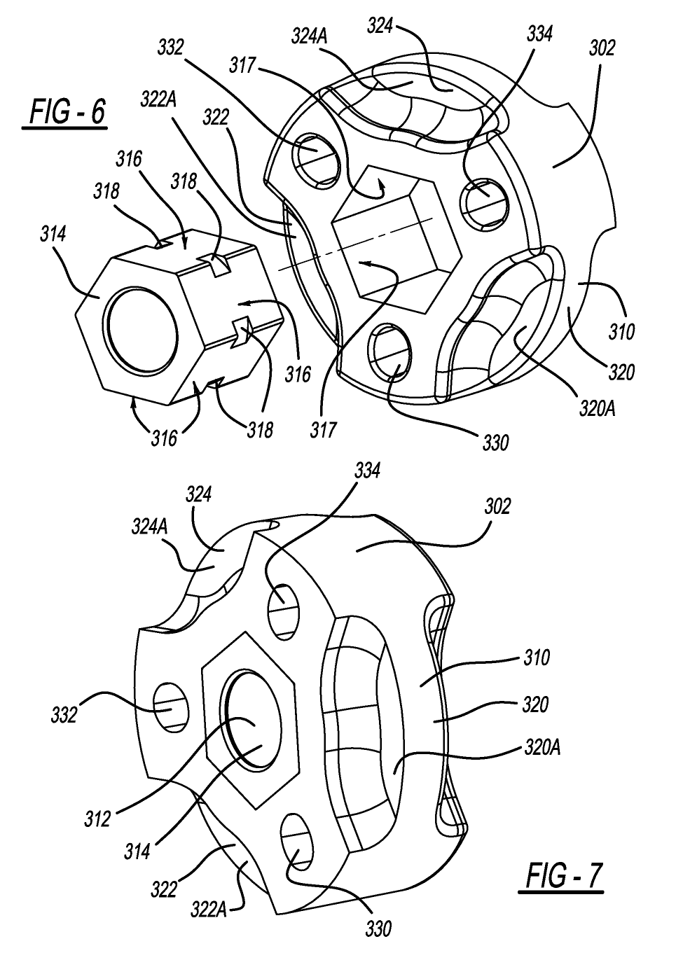

With reference to FIGS. 6 and 7, a coupling hub 302 constructed in accordance to additional features of the present disclosure will be described. Unless otherwise explained herein, the coupling hub 302 can be constructed similar to the coupling hub 180. The coupling hub 302 can have a hub body 310 that defines a central bore 312 configured to receive the second end portion 192 of the input shaft 154. The hub body 310 can be formed of over-molded plastic having a metal insert 314. The metal insert 314 can have a hexagonal outer profile that resists rotation relative to the remainder of the hub body 310. Explained further, the hexagonal outer profile includes a series of six planer surfaces 316 that oppose complementary planar surfaces 317 on the hub body 310. The planar surfaces 316 and 317 cooperate to inhibit relative rotation of the metal insert 314 and the hub body 310. Further, the metal insert 314 includes an undercut geometry that includes inset portions 318 to resist axial slip between the metal insert 314 of the hub body 310. It will be appreciated that material of the hub body 310 will extend into the inset portions 318.

The hub body 310 can further have a plurality of lobes 320, 322 and 324. Additional or fewer lobes may be incorporated according to torque transfer requirements of a particular application. Adjacent lobes 320 and 322 define a first opening or pin receiver 330. Adjacent lobes 322 and 324 define a second opening pin receiver 332. Adjacent lobes 324 and 320 define a third opening or pin receiver 334. The lobes 320, 322 and 324 can include respective ribs 320A, 322A and 324A formed thereon. The ribs 320A, 322A and 324A strengthen the coupling hub 302. The collective pin receivers 330, 332 and 334 are configured to selectively receive first ends of pins 240 (only one specifically shown in FIG. 3 and two shown in FIG. 4). Opposite ends of the pins 240 are received by the first timing gear 170. In one example the hub body 310 can be formed of Polyether ether ketone (PEEK) and the insert can be formed of steel such as 4140 steel. Other materials are contemplated.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A coupling assembly arranged between an input shaft and a rotor shaft of a supercharger, the coupling assembly comprising:
a coupling hub having a series of lobes wherein adjacent lobes of the series of lobes define a plurality of openings, the coupling hub further defining a mounting bore therein;
a plurality of pins having first ends and second ends, wherein the first ends are correspondingly received by the plurality of openings and the second ends are received by the rotor shaft; and
wherein the input shaft is directly mounted into the mounting bore of the coupling hub for concurrent rotation therewith.

2. The coupling assembly of claim 1 wherein the first end of the input shaft is press fit into the mounting bore of the coupling hub.

3. The coupling assembly of claim 2 wherein the second ends of the plurality of pins are directly received by corresponding openings on the rotor shaft.

4. The coupling assembly of claim 1 wherein the series of lobes consists of three lobes.

5. The coupling assembly of claim 4 wherein the plurality of openings consists of three openings.

6. The coupling assembly of claim 5 wherein the plurality of pins consists of three pins.

7. The coupling assembly of claim 1, further comprising the input shaft wherein the input shaft comprises:
a first end portion;
a second end portion; and
an intermediate portion that connects the first end portion and the second end portion;
wherein the first end portion is coupled to a pulley and the second end portion is directly mounted into the mounting bore of the coupling hub, wherein the second end portion has a reduced diameter as compared to the intermediate portion.

8. The coupling assembly of claim 1 wherein the coupling hub is one-piece.

9. The coupling assembly of claim 1 wherein each lobe of the series of lobes includes a rib formed thereon, the rib configured to strengthen the coupling hub.

10. The coupling assembly of claim 1 wherein the coupling hub has a hub body formed of over-molded plastic and an insert formed of metal.

11. The coupling assembly of claim 10 wherein the insert has a hexagonal outer profile.

12. The coupling assembly of claim 11 wherein the metal insert comprises a series of first planar surfaces that oppose a complementary series of second planar surfaces on the hub body, wherein the first and second planar surfaces cooperate to resist relative rotation between the hub body and the insert.

13. The coupling assembly of claim 12 wherein the insert includes an undercut geometry thereon.

14. The coupling assembly of claim 13 wherein the undercut geometry includes a series of inset portions thereon configured to resist axial slip between the insert and the hub body.

15. The coupling assembly of claim 10 wherein the plurality of openings are closed around a circumference of the hub body.

16. A coupling assembly arranged between an input shaft and a rotor shaft of a supercharger, the coupling assembly comprising:
a coupling hub having a series of lobes wherein adjacent lobes of the series of lobes define a plurality of openings, the coupling hub further defining a mounting bore therein, wherein the coupling hub is one-piece and comprises a hub body formed of plastic and an inert formed of metal, the hub body having a series of first planar portions that oppose a complementary series of second planar surfaces on the hub body, the first and second planar surfaces cooperating to resist relative rotation between the hub body and the insert;
a plurality of pins having first ends and second ends, wherein the first ends are correspondingly received by the plurality of openings and the second ends are received by the rotor shaft; and
wherein the input shaft is directly mounted into the mounting bore of the coupling hub for concurrent rotation therewith.

17. The coupling assembly of claim 16 wherein the insert includes an undercut geometry thereon.

18. The coupling assembly of claim 16 wherein the undercut geometry includes a series of inset portions thereon configured to resist axial slip between the insert and the hub body.

19. The coupling assembly of claim 16 wherein the plurality of openings are closed around a circumference of the hub body.

20. The coupling assembly of claim 16, further comprising the input shaft wherein the input shaft comprises:
a first end portion;
a second end portion; and
an intermediate portion that connects the first end portion and the second end portion;
wherein the first end portion is coupled to a pulley and the second end portion is directly mounted into the mounting bore of the coupling hub, wherein the second end portion has a reduced diameter as compared to the intermediate portion.
